(19) United States
(12) Patent Application Publication
(10) Pub. No.: US 2008/0100432 A1
(43) Pub. Date: May 1, 2008

(54) VEHICLE PULSE FLASHER UNIT

(75) Inventor: Lawrence Andrew Hoffman, Portland, OR (US)

Correspondence Address: PAUL J. FORDENBACHER;SILICON FOREST PATENT GROUP, 11876 NW TYLER CT., PORTLAND, OR, 97229, US

(73) Assignee: The Hoffman Group International, Ltd., Tortola (VG)

(21) Appl. No.: 11/929,834

(22) Filed: Oct. 30, 2007

Related U.S. Application Data
(60) Provisional application No. 60/863,410, filed on Oct. 30, 2006.

(51) Int. Cl. B60Q 1/34

(52) U.S. Cl. 340/475

(57) ABSTRACT

Embodiments in accordance with the present invention relate to providing a turn signal flasher unit that controls the operation of the vehicle turn signal lamps. The turn signal flasher unit provides a plurality of user-defined modes of operation, including, but not limited to: a continuous cycle of switching from a voltage output of zero to an output of H, in an operation referred to as traditional flash mode; a continuous cycle of raising from a voltage output of zero to an output of H and back down to zero at a predetermined adjustable rate, in an operation referred to as full cycle pulse mode; and a cycle of a half cycle pulse mode circuit adapted to provide cycling between a continuous raising from a voltage output of zero to an output of H, in an operation referred to as half-cycle pulse mode.

### RELATED APPLICATION

This application is a non-provisional application claiming the benefit of U.S. Provisional Application No. 60/863,410, filed Oct. 30, 2006, incorporated herein in its entirety by reference.

### FIELD

The present invention is related to vehicle components, and more particularly, to flasher units for controlling turn signal and hazard lights.

### BACKGROUND

Vehicle turn signals comprise flashing front and rear lights on the left or right hand side of the vehicle depending on the direction of the turn, a hazard signal comprises flashing front and rear lights on both the left and right hand sides of the vehicle, and a brake light signal comprises the steady illumination of the rear lights on both the left and right hand sides of the vehicle. The flashing operation is facilitated by a flasher unit that supplies an on-off signal to an illumination control circuit.

Many different electrical circuits have been used for this purpose. The standard practice has been to switch high current within the turn and hazard switches of the vehicle with the flashing controlled by opening and closing a contact within the well known thermal flasher. The thermal flasher effectively opens and closes an electrical contact at a constant, predetermined rate and duration that is not adjustable by the user. Integrated circuit (IC) based flashers are also available that sends a signal to open and close a circuit, but also at a constant, predetermined rate and duration that is not adjustable by the user.

Many automobile enthusiasts desire to provide their automobile with unique and aesthetically-pleasing features. One desire is to be able to control the flashing characteristics of the automobile lights.

It would, therefore, be highly desirable to have an improved flasher that provides vehicle manufacturers, aftermarket, and custom vehicle enthusiasts a means to customize the operation of the turn signal lamps. Further, it would be highly desirable that the improved turn signal flasher be a simple modular plug replacement for the standard stock flasher commonly provided in the fuse box of the vehicle.

### BRIEF DESCRIPTION OF THE DRAWINGS

Like reference numbers generally indicate corresponding elements in the figures.

FIG. 1 is a schematic of a pulse flasher unit in accordance with an embodiment of the present invention; and

FIG. 2 is a schematic of a turn signal circuit comprising a pulse flasher unit and an illumination control circuit, in accordance with an embodiment of the present invention.

### DETAILED DESCRIPTION

References will now be made to embodiments illustrated in the drawings and specific language which will be used to describe the same. It will nevertheless be understood that no limitation of the scope of the invention is thereby intended, such alterations and further modifications in the illustrated devices, as such further applications of the principles of the invention as illustrated therein as being contemplated as would normally occur to one skilled in the art to which the invention relates.

Embodiments in accordance with the present invention relate to providing a turn signal flasher unit that controls the operation of the vehicle turn signal lamps. The turn signal flasher unit provides a plurality of user-defined modes of operation, including, but not limited to: a continuous cycle of switching from a voltage output of zero to an output of H (high), in an operation referred herein as traditional flash mode; a cycle of continuously raising from a voltage output of zero to an output of H and back down to zero at a predetermined adjustable rate (fade on/fade off), in an operation referred herein as full cycle pulse mode; and a cycle of continuously raising from a voltage output of zero to an output of H (fade on), in an operation referred herein as half-cycle pulse mode.

It is understood that other vehicle lights may be controlled by the flasher unit. The turn signal lamps are used herein by way of example, but other vehicle lights, such as, but not limited to, headlights and tail-lights may be similarly controlled.

Circuits are provided for a user to switch the flasher unit to operate in one of a plurality of modes of operation. Regarding the traditional flash mode, circuits are also provided for the user to adjust the frequency (the number of times per unit of time) of the switching between an output of zero and an output of H. This results in the left or right, or when in hazard mode, both left and right, turn signal lamps, being switched from off to on in a discrete manner at a user-controlled frequency.

Regarding the full cycle pulse mode, circuits are also provided for the user to adjust the frequency of the cycling of continuous voltage rising from an output of zero to an output of H and voltage fall back down to zero at substantially the same rate as the rise; fade on/fade off. This results in the left or right, or when in hazard mode, both left and right turn, signal lamps increasing and decreasing in intensity of illumination at a user-controlled frequency.

Regarding the half cycle pulse mode, means are also provided for the user to adjust the frequency of the cycling of continuous voltage rising from an output of zero to an output of H; fade on. This results in the left or right, or when in hazard mode, both left and right, turn signal lamps increasing in intensity of illumination then abruptly off, at a user-controlled frequency.

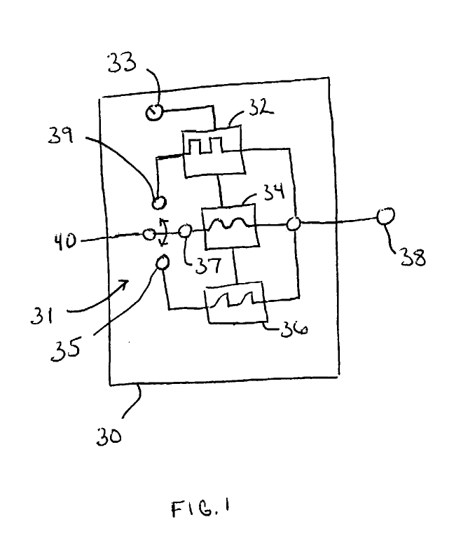

FIG. 1 is a schematic of a pulse flasher unit 30 in accordance with an embodiment of the present invention. The pulse flasher unit 30 comprises a mode switch 31, a flash mode circuit 32, a full cycle pulse mode circuit 34, a half cycle pulse mode circuit 36, a variable frequency switch 33, a voltage source contact 40, and an output contact 38. The mode switch 31 completes an electrical circuit between the voltage source contact 40 and the output contact 38 through one of the flash mode circuits 32, full cycle pulse mode circuit 34, and half cycle pulse mode circuit 36, via contacts 35, 37, 39, respectively . The variable frequency switch 33 controls the frequency of the cycles of the respective mode circuits 32, 34, 36. In an embodiment in accordance with the present invention, the variable frequency switch 33 is a continuously variable frequency switch 33. In an embodiment in accordance with the present invention, the variable frequency switch 33 is a discrete variable frequency switch having a plurality of predetermined frequency setting.

The flash mode circuit 32 is adapted to provide cycling between an output of zero and an output of H (high). Circuits are known in the art that provide such a cycling mode of operation. In accordance with an embodiment of the present invention, the flash mode circuit 32 is adapted to provide a square-wave-type voltage output to output contact 38. In another embodiment, the flash mode circuit 32 is the well known thermal flasher circuit. In yet another embodiment, the flash mode circuit 32 is a relay. In yet another embodiment, the flash mode circuit 32 includes a flasher relay having an energizable coil and a contact operable by energization and de-energization of the coil by relatively low steady electrical current or absence thereof, respectively, to cause the intermittent current to be supplied to the first and second relay contacts, and an IC flasher unit operable to effect said energization and de-energization of the coil.

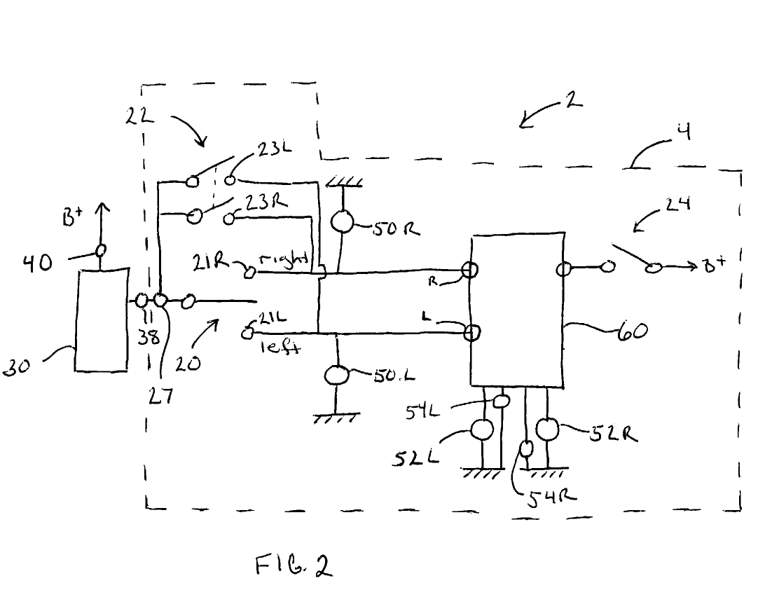

In another embodiment, the flash mode circuit 32 is provided by relatively low current circuitry comprising an IC (integrated circuit) chip connected to a CMOS (Complementary metal-oxide-semiconductor) oscillator running at the flashing frequency of the lamps. The oscillator biases transistors on and off as current flows through the turn signal circuit 4, as shown in FIG. 2, when one or both of the switches is closed. The current for the lamps is obtained from the power supply through contacts of a relay which controls the lamps on the right side or through contacts of the relay which controls the lights on the left side.

The full cycle pulse mode circuit 34 is adapted to provide cycling between a continuous rising from a voltage output of zero to an output of H and a continuous descend back down to zero at substantially the same rate as the rise. In accordance with an embodiment of the present invention, the full cycle pulse mode circuit 34 is adapted to provide a sine-wave-type voltage output wherein the second half of the sine wave is inverted so as to provide two pulse cycles per sine-wave cycle to output contact 38. Providing two pulse cycles per sine-wave cycle, using an inverter or otherwise, does not produce a protracted half-cycle off portion such as would happen if only one pulse per sine-wave cycle were used. This provides a more aesthetically pleasing effect as well as providing a better visual alert for increased safety. The off-time portion of the cycle should be minimized.

It is understood and appreciated that other voltage wave-forms may be provided in accordance with the present invention. Other voltage waveforms include, but are not limited to, triangle, saw tooth, and step waveforms. A triangle or saw tooth voltage waveform produces a continuous linear rate of the voltage raise and fall. Step waveforms would provide a raise and fall of voltage in increasing and decreasing discrete steps, respectively.

The half cycle pulse mode circuit 36 is adapted to provide cycling between a continuous rising from an output of zero to an output of H. In accordance with an embodiment of the present invention, the half cycle pulse mode circuit 36 is adapted to provide a sine-wave-type voltage output for the rise-portion and a square wave-type voltage output for the fall-portion of the cycle to output contact 38. As described for the full-cycle mode, the off-time should be minimized for aesthetic and safety reasons.

It is understood and appreciated that other voltage wave-forms may be provided in accordance with the present invention. Other voltage waveforms include, but are not limited to, triangle, saw tooth, and step waveforms. A triangle or saw tooth voltage waveform produces a continuous linear rate of the voltage raise. Step waveforms would provide a raise of voltage in increasing discrete steps.

FIG. 2 is a schematic of a turn signal circuit 2 comprising a pulse flasher unit 30 and a known lamp circuit 4, in accordance with an embodiment of the present invention. The lamp circuit comprises a battery B+, interior indicator lamps 50R, 50L, a turn indicator switch 20, a hazard switch 22 with left and right contacts 23L, 23R, a brake switch 24, rear exterior indicator lamps 52R, 52L, front exterior indicator lamps 54R, 54L, and an exterior indicator lamp controller 60. The turn indicator switch 20 includes a pair of contacts 21R, 21L opened and closed during a turn indication operation of the switch 20 so as to provide voltage to either of the right or left interior and exterior indicator lamps 50R, 52R, 54R, 50L, 52L, 54L. The turn indicator switch 20 is manually operable to engage contact 21R when it is desired to indicate a right turn and to engage contact 21L when it is desired to indicate a left turn.

The hazard switch 22 includes a pair of contacts 21R, 21L simultaneously opened and closed during a hazard indication operation of the switch 22 so as to provide voltage to all of the right and left interior and exterior indicator lamps 50R, 52R, 54R, 50L, 52L, 54L.

The pair of right turn signal exterior indicator lamps 52R, 54R and the right interior indicator lamp 50R are connected in parallel between ground and both the turn indicator switch 20 and the hazard switch 22. The pair of left turn signal exterior indicator lamps 52L, 54L and the left interior indicator lamp 50L are connected in parallel between ground and both the turn indicator switch 20 and the hazard switch 22.

The interior indicator lamps 50R, 50L are positioned within the vehicle so as to be easily observed by the operator.

The brake switch 24 enables current to both of the exterior rear left and right indicator lamps 52R, 52L to indicate a braking condition. The exterior indicator lamp controller 60 controls the voltage to the right and left exterior indicator lamps 52R, 54R, 52L, 54L so as to control the priority of operation of the exterior indicator lamps 52R, 54R, 52L, 54L between the brake operation and the hazard/turn indicator operation.

When it is desired to indicate a left or right turn, the vehicle operator positions the turn indicator switch 20 to engage either the contacts 21R or 21L, respectively. A conduction path is then provided from the battery B+, through the voltage source input contact 40, through the pulse flasher unit 30 to the an output contact 38, to the right or left interior and exterior lamps 50R, 52R, 54R or 50L, 52L, 54L, respectively.

In accordance with an embodiment of the present invention, a pulse flasher unit 30 provides an intermittent signal source to a lamp controller 60. In an embodiment, the lamp controller 60 includes a logic circuit including a relay for connecting the right and left exterior indicator lamps 52R, 54R, 52L, 54L to a first switch for continuously lighting the exterior indicator lamps 52R, 54R, 52L, 54L or a second switch for operating the exterior indicator lamps 52R, 54R, 52L, 54L to flash or pulse by connecting to the pulse flash unit 30.

As is known in the art, flasher units are commonly modular units that couple to the vehicle lamp circuit 4 via a plug and socket. The socket is commonly found in a fuse or relay box in the interior of the vehicle under the dash. In accordance with an embodiment of the present invention, the pulse flasher unit 30 includes a plug, and extending therefrom, a pair of blades. Each blade is electrically connected to one of the contacts 38, 40, respectively, of the pulse flasher unit 30, as shown in FIG. 2. A socket is provided in the turn signal circuit 2 and has a pair of slots each electrically connected to one of the battery B+ and contact 27, respectively. When the blades of the plug are pushed into the slots of the socket, a removable electrical connection is made between the pulse flasher unit 30 and the lamp circuit 4.

The pulse flasher unit 30 comprises a mode switch 31 that is accessible by the user such that the user can switch between one of multiple modes of operation. Such a switch can be operated, such as, but not limited to, by a knob located on a housing of the pulse flasher unit 30.

The pulse flasher unit 30 comprises a variable frequency switch 33 that controls the frequency of the cycles of the respective mode circuits 32, 34, 36 either continuously throughout a predetermined range or by discrete values within a range. The variable frequency switch 33 is assessable by the user such that the user can control the frequency of the cycles. Such a switch may comprise, such as, but not limited to, a variable potentiometer controlled by a knob located on a housing of the pulse flasher unit 30.

The pulse flasher unit 30 comprises at least two of the following: a voltage control means having the property of energizing the lamps with a continuous cycle from a voltage output of zero to an output of H and back down to zero at a predetermined adjustable rate, in an operation referred to as full cycle pulse mode; a voltage control means having the property of energizing the lamps with a continuous cycle from an output of zero to a voltage output of H, in an operation referred to as half-cycle pulse mode; and a voltage control means for a continuous cycle of switching from a voltage output of zero to an output of H, in an operation referred to as traditional flash mode.

According to embodiments of the invention, there is provided an automotive vehicle signaling system comprising, in combination, a grounded lamp load; a grounded source of potential; and a pulse flasher unit including a flasher input contact connected to the ungrounded terminal of said source of potential, a flasher output contact connected to said lamp load, a mode switch, and a frequency switch.

According to embodiments of the invention, there is provided in lamp controller 60, which may be a relay connected to switch to the first switch for continuously lighting the lamp or the second switch for operating to pulse flash by connecting to the pulse flash unit 30 providing the intermittent signal source, when both of the first switch and the second switch are made ON, the switch mode determining circuit operates to flash the lamp by connecting the relay to the second switch by the relay driving means based on the ON state of the second switch and therefore, for example, when the first switch is constituted by the stop lamp switch of the vehicle and the second switch is constituted by the hazard switch, there is achieved a priority function of urging caution to a succeeding vehicle by flashing the lamp based on the hazard switch when both switches are made ON.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

What is claimed is:

1. A pulse flasher unit comprising:
a flash mode circuit adapted to provide discrete cycling of a voltage output of zero and an output of H;
a full cycle pulse mode circuit adapted to provide cycling between a continuous rising from a voltage output of zero to an output of H and back down to zero;
a half cycle pulse mode circuit adapted to provide cycling between a continuous raising from a voltage output of zero to an output of H;
a mode switch;
a variable frequency switch operable for controlling the frequency of the flash mode circuit, full cycle pulse mode circuit, and half cycle pulse mode circuits;
a voltage source input contact; and
an output contact, the mode switch operable for completing an electrical circuit between the power source and the output through one of the flash mode circuit, full cycle pulse mode circuit, and half cycle pulse mode circuit.

2. A turn signal circuit comprising:
a pulse flasher unit comprising:
a flash mode circuit adapted to provide cycling between a voltage output of zero and an output of H;
a full cycle pulse mode circuit adapted to provide cycling between a continuous rising from a voltage output of zero to an output of H and back down to zero;
a half cycle pulse mode circuit adapted to provide cycling between a cycle of continuously raising from a voltage output of zero to an output of H;
a mode switch;
a variable frequency switch operable for controlling the frequency of the flash mode circuit, full cycle pulse mode circuit, and half cycle pulse mode circuits;
a voltage source input contact; and
an output contact, the mode switch operable for completing an electrical circuit between the power source and the output contact through one of the flash mode circuit, full cycle pulse mode circuit, and half cycle pulse mode circuit; and
a lamp circuit comprising a battery terminal, interior indicator lamps, a turn indicator switch, a hazard switch, a brake switch, rear exterior indicator lamps, front exterior indicator lamps, and an exterior indicator lamp controller, the lamp circuit in electrical communication with the pulse flasher unit, the turn indicator switch including a pair of contacts opened and closed during a turn indication operation of the switch so as to provide voltage control by the pulse flasher unit to either of the right or left interior and exterior indicator lamps, the turn indicator switch manually operable to engage contact when it is desired to indicate a right turn and to engage contact when it is desired to indicate a left turn.

3. An automotive vehicle signaling system comprising:
a grounded lamp load;
a grounded source of potential; and
a pulse flasher unit including a flasher input contact connected to the ungrounded terminal of said source of potential, a flasher output contact connected to the lamp load, the pulse flasher unit further comprising:
a flash mode circuit adapted to provide cycling between a voltage output of zero and an output of H;
a full cycle pulse mode circuit adapted to provide cycling between a continuous rising from a voltage output of zero to an output of H and back down to zero;
a half cycle pulse mode circuit adapted to provide cycling between a continuous raising from a voltage output of zero to an output of H;
a mode switch;
a variable frequency switch operable for controlling the frequency of the flash mode circuit, full cycle pulse mode circuit, and half cycle pulse mode circuits, the mode switch operable for completing an electrical circuit between the source of potential and the output through one of the flash mode circuits, full cycle pulse mode circuit, and half cycle pulse mode circuit.
